(19) United States
(12) Patent Application Publication
(10) Pub. No.: US 2025/0004177 A1
(43) Pub. Date: Jan. 2, 2025

(54) LENS

(71) Applicant: SAMSUNG ELECTRO-MECHANICS CO., LTD., Suwon-si (KR)

(72) Inventors: Tae Kyung LEE, Suwon-si (KR); Je Hong KYOUNG, Suwon-si (KR); Yong Suk KIM, Suwon-si (KR); Joung Hun KIM, Suwon-si (KR); Byung Ju KIM, Suwon-si (KR); Jung Ho LEE, Suwon-si (KR); Na Yi KANG, Suwon-si (KR)

(73) Assignee: SAMSUNG ELECTRO-MECHANICS CO., LTD., Suwon-si (KR)

(21) Appl. No.: 18/440,053

(22) Filed: Feb. 13, 2024

(30) Foreign Application Priority Data
Jun. 29, 2023 (KR) 10-2023-0084294

(51) Int. Cl. G02B 1/115; G02B 1/14; G02B 1/18; G02B 3/00

(52) U.S. Cl. CPC G02B 1/115; G02B 1/14; G02B 1/18; G02B 3/0087

(57) ABSTRACT

A lens includes a lens portion; a multilayer anti-reflective (AR) coating layer, including either one or both of a low refractive index layer and a high refractive index layer, disposed on one surface of the lens portion; and a water-repellent layer, including a water repellent, disposed on one surface of the multilayer AR coating layer. Either one or both of the low refractive index layer and the high refractive index layer are formed of a nitride-based material with a band gap greater than 3.1 eV.

### CROSS-REFERENCE TO RELATED APPLICATIONS

This application claims the benefit under 35 USC 119 (a) of Korean Patent Application No. 10-2023-0084294 filed on Jun. 29, 2023, in the Korean Intellectual Property Office, the entire disclosure of which is incorporated herein by reference for all purposes.

### 1. FIELD

The following description relates to a lens.

### 2. DESCRIPTION OF THE BACKGROUND

Automobile electrical component-related technologies, such as advanced driver assistance system (ADAS), autonomous driving, and the like, are continuously being developed, along with an electric camera module and an optical sensor.

Specifically, the market for a camera module using a lens is growing rapidly. Cameras used in vehicles have also been adopted in various positions, such as front/rear/side.

However, for a camera for a vehicle, because the camera is externally exposed most times, defects such as foreign matter adsorption, lens surface contamination, and scratches may often occur due to external environments, and such defects may influence the performance of a camera module.

An outermost lens of lenses used for an electrical component may implement anti-reflective properties in a multilayer stack structure, and commonly used materials may include oxide-based materials such as TiO2, SiO2, and the like.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens includes a lens portion; a multilayer anti-reflective (AR) coating layer, including either one or both of a low refractive index layer and a high refractive index layer, disposed on one surface of the lens portion; and a water-repellent layer, including a water repellent, disposed on one surface of the multilayer AR coating layer. Either one or both of the low refractive index layer and the high refractive index layer are formed of a nitride-based material with a band gap greater than 3.1 eV.

The low refractive index layer may include a first layer formed of SiO₂, and the high refractive index layer comprises a second layer formed of TiO₂.

The low refractive index layer may include a fourth layer formed of a nitride-based material, and the high refractive index layer may include a third layer formed of a nitride-based material.

The fourth layer may be formed of TiN, and the third layer may be formed of either Si₃N₄ or AlN.

A thickness of the fourth layer may be 50 nm or less.

The low refractive index layer may include a first layer formed of SiO₂ and a fourth layer formed of a nitride-based material, and the high refractive index layer may include a second layer formed of TiO₂ and a third layer formed of a nitride-based material.

In the multilayer AR coating layer, the first layer and the second layer may be alternately stacked, and an uppermost portion thereof may be a third layer or a fourth layer.

The low refractive index layer may include a first layer formed of SiO₂, and the high refractive index layer may include a third layer formed of a nitride-based material.

On the first layer of an uppermost end of the multilayer AR coating layer, either one or both of the third layer and a fourth layer, a low refractive index layer formed of a nitride-based material, may be further disposed as one or more layers.

The low refractive index layer may include a fourth layer formed of a nitride-based material, and the high refractive index layer may include a second layer formed of TiO₂.

On the second layer of an uppermost end of the multilayer AR coating layer, either one or both of the fourth layer and a third layer, a high refractive index layer formed of a nitride-based material, may be further disposed as one or more layers.

In the multilayer AR coating layer, a first layer and a second layer may be alternately stacked, and a third layer having a high refractive index or a fourth layer having a low refractive index, formed of a nitride-based material, may be disposed in an intermediate portion thereof.

Either the third layer or the fourth layer may be formed to be thicker than the first layer and the second layer.

Either one or both of the third layer or the fourth layer may be further disposed at an uppermost end of the multilayer AR coating layer as one or more layers.

The lens may further include a functional coating layer, including a UV improvement additive, disposed between the multilayer AR coating layer and the water-repellent layer.

Other features and aspects will be apparent from the following detailed description, the drawings, and the claims.

### BRIEF DESCRIPTION OF DRAWINGS

FIG. 1 is a perspective view schematically illustrating a lens according to an example embodiment of the present disclosure.

FIG. 2 is a cross-sectional view illustrating an AR coating layer comprised of SiO₂ and TiO₂ as a conventional example.

FIGS. 3 to 23 are cross-sectional views illustrating various example embodiments of an AR coating layer of the present disclosure.

FIG. 24 is a graph illustrating Mohs hardness for each material.

FIGS. 25 to 28 are conceptual diagrams and tables illustrating a band gap of a material suitable for optical AR coating.

FIG. 29 is a graph illustrating a band gap for each material.

FIG. 30 is a graph illustrating the transmittance of each material.

FIG. 31 is a graph illustrating the nano-indicator measurement results for each material.

FIGS. 32 and 33 are conceptual diagrams illustrating a single-layer structure of a discrete refractive index.

FIG. 34 is a conceptual diagram illustrating a discrete refractive index multilayer structure.

FIG. 35 is an exploded view schematically illustrating a digital camera structure according to an example embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In a lens structure including a water-repellent layer of the present disclosure, at least one layer of an anti-reflective (AR) coating layer may be formed of a nitride-based material, or an entire AR coating layer may be formed of a nitride-based material, in which the material is selected to have a characteristic in which a band gap exceeds 3.1 eV, thereby improving the hardness of the lens.

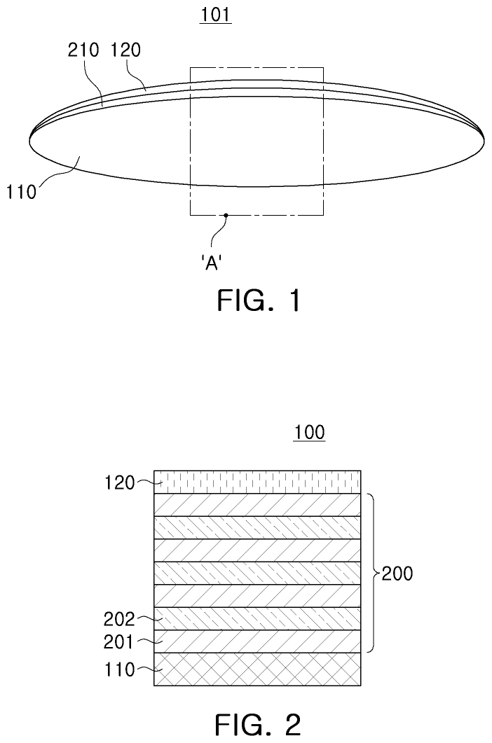

FIG. 1 is a perspective view schematically illustrating a lens according to an example embodiment of the present disclosure.

Referring to FIG. 1, a lens 101, according to an embodiment of the present disclosure, includes a lens portion 110, an anti-reflective (AR) coating layer 210, and a water-repellent layer 120.

For the lens portion 110, a shape or type thereof is not particularly limited, and may be implemented in the form of a lens that may be used in an optical device such as a camera module.

Accordingly, the shape of the lens portion 110 may be formed to have a shape other than that illustrated in FIG. 1.

The lens portion 110 may be formed of a glass. However, the lens portion 110 may be formed of another material, for example, a plastic resin including a resin component.

For example, the plastic resin may include at least one of polycarbonate and polyolefin.

Here, the polyolefin may include at least one of a cycloolefin polymer and a cycloolefin copolymer.

The AR coating layer 210 may serve to reduce the reflectance of a surface of the lens 101, thus reducing or preventing a flare phenomenon.

When the AR coating layer is formed of a single layer, a refractive index of n2 may be optimized under the same conditions as in FIG. 32 and Equation 1. Here, n2 is an AR coating layer, and n3 is a substrate.

### Equation 1:

$${n}_{2 =} \sqrt{{n}_{1} \times {n}_{3}} \qquad ( 1 )$$

$${n}_{2} \times t = \frac{λ}{4} \qquad ( 2 )$$

If n1 is air and has a refractive index of 1 and n3 has a refractive index of 1.5, an ideal refractive index of n2 may be minimized if it comes to 1.225.

However, none of the existing materials have a refractive index value of about 1.2, and the lowest material is known to have a refractive index in the late 1.3 range.

Additionally, a layer thickness t of n2 may be calculated when a wavelength of an application to be used is added to Equation 2.

In general, an ideal thickness of the n2 layer is about 112 nm based on 550 nm, a visible light range.

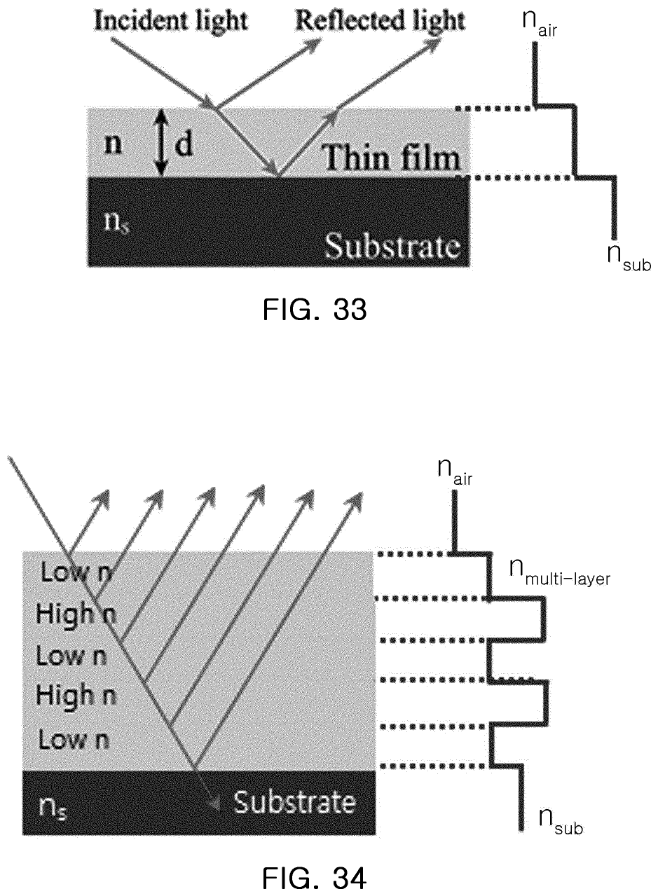

Additionally, in FIG. 33, when a layer having a different refractive index is applied for each substrate or layer, reflections occur at an interface due to changes in discrete refractive index values.

For improvement thereof, an AR coating with a multilayer stack structure of a Bragg reflector structure, as illustrated in FIG. 34, is generally applied.

The multilayer AR coating layer has a structure in which a low refractive index layer and a high refractive index layer are repeatedly stacked.

However, when the AR coating layer consists of a SiO₂ layer and a TiO₂ layer, the lowest reflectance is about 0.5%, and when a recent under-display cover glass of a mobile phone is applied, or an additional optical layer is applied, the reflectance requires a lower value.

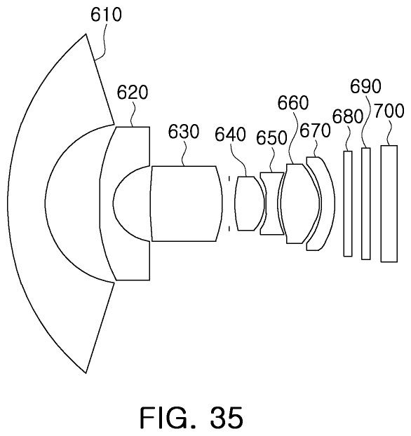

In consideration thereof, in order to implement ultra-low reflection, a refractive index does not change discretely. As illustrated in FIG. 35, it is advantageous to have a structure in which the refractive index gradually changes from air to substrate.

This structure may be seen as a structure that clearly reduces the number of reflections at the interface because there is no interface where the refractive index changes rapidly, but the structure is difficult to implement in a real system.

Accordingly, in consideration of all of these points, an outermost lens among lenses used for an electrical component should eventually implement anti-reflective in a multilayer stack structure.

Referring to FIG. 2, an AR coating layer 200 (hereinafter, an intermediate layer being indicated in parallel with the AR coating layer) of a conventional lens 100 includes a multilayer structure in which a first layer 201 and a second layer 202 having different refractive indices are alternately stacked at least once. Here, the reference numeral 110 is a lens portion, and the reference numeral 120 is a water-repellent layer.

In this case, the first layer 201 is formed of SiO₂ as a low refractive index layer, and the second layer 202 is formed of TiO₂ as a high refractive index layer.

However, when the AR coating layer 200 consists of the first layer 201 and the second layer 202, oxide-based materials such as TiO₂ and SiO₂ have a weak hardness that may easily cause scratches on the surface of the lens due to an external environment.

Such scratches may cause video errors during autonomous driving and the like, which may lead to vehicle accidents.

In an example embodiment of the present disclosure, in order to improve hardness, the AR coating layer is configured by replacing part or all of the first layer with a fourth layer, a low refractive index layer, or replacing part or all of the second layer with a third layer, a high refractive index layer.

Additionally, the AR coating layer may be formed by replacing some or all of the first layers with the fourth layer, a low refractive index layer, and replacing some or all of the second layers with the third layer, a high refractive index layer.

In this case, a criterion for distinguishing between materials with a high refractive index and a low refractive index is a refractive index of 1.5.

The material with a low refractive index is a material with a refractive index of less than 1.5, and the material of the high refractive index is a material with a refractive index of 1.5 or more.

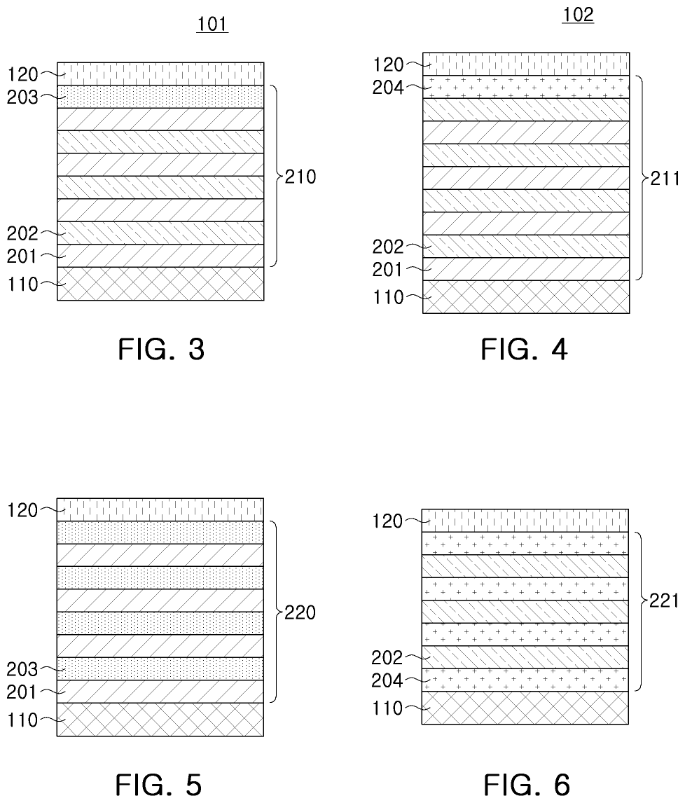

Referring to FIG. 3, the AR coating layer 210 of the lens 101 includes a first layer 201 and a second layer 202 alternately stacked from a lower end, and a third layer 203, a high refractive index layer, disposed on the first layer 201, a low refractive index layer, at an uppermost end thereof.

The AR coating layer 200 may be formed by coating one surface of the lens portion 110 in an E-beam process using E-beam evaporator equipment having a thermal device.

Additionally, referring to FIG. 4, in another example, an AR coating layer 211 of a lens 102 includes a first layer 201 and a second layer 202 alternately stacked from a lower end, and a fourth layer 204, a low refractive index layer, disposed on the second layer 202, a high refractive index layer, at an uppermost end thereof.

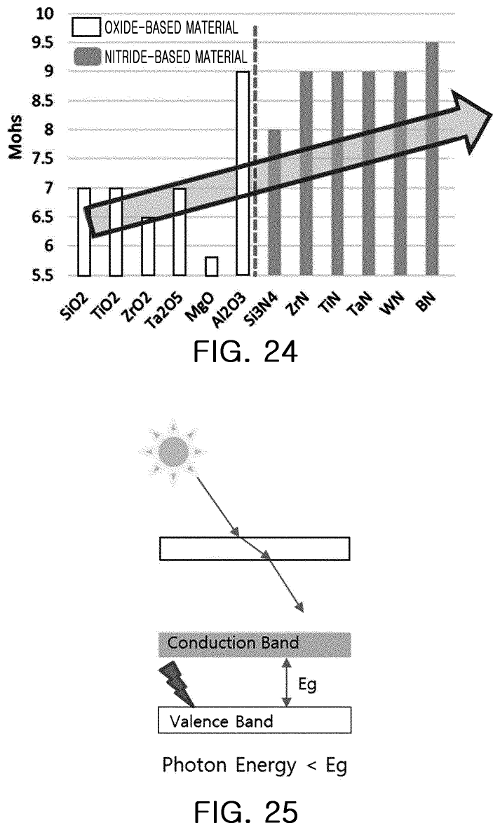

Referring to FIG. 24, to increase the hardness of the AR coating layer, a nitride- or a carbide-based material may be selected rather than an oxide-based material.

However, the carbide-based material may require high-temperature deposition when depositing thin films or mainly use a CVD method. Thus, a high vacuum deposition facility may be desired, increasing deposition costs.

In order for the carbide-based material to be used for the AR coating layer, band gap characteristics of the material are decisive.

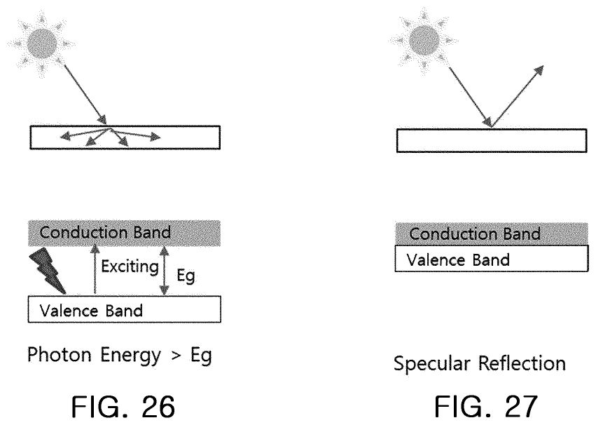

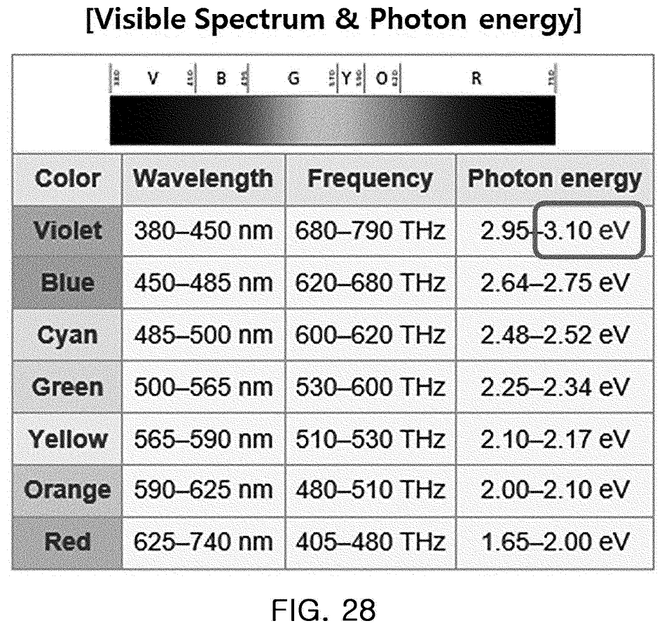

FIGS. 25 to 28 are conceptual diagrams and tables illustrating a band gap of a material suitable for optical AR coating.

Referring to FIGS. 25 to 28, when a band gap of the material is smaller than photon energy depending on a wavelength, an incident photon may not be transmitted through a layer and may be absorbed.

Additionally, reflection may occur when a band gap of the material has a low band gap that is very close to a conduction band and a valence band.

A nitride-based material used in the third layer 203 and the fourth layer 204 is used to have a characteristic in which a band gap exceeds 3.1 eV among all nitride-based materials.

Additionally, among the nitride-based materials with higher hardness than oxide-based materials, materials with a band gap greater than 3.1 eV are selected, as illustrated in Table 1 below.

TABLE 1

| | | | | | |
|---|---|---|---|---|---|
| | Density | Melting Point | Band Gap | Mohs (bulk | Reflec- |
| Material | (g/cm³) | (É) | (eV) | or crystal) | tance |

Nitride-based material

| | | | | | |
|---|---|---|---|---|---|
| Si₃B₄ | 3.2 | 1900 | 5.1 | 8.0 | 2.02 |
| TiN | 5.2 | 2947 | 3.4 | 9.0 | 1.38 |
| BN | 3.5 | 2973 | 6.4 | 9.5 | 2.10 |
| AlN | | | 6.2 | 8.5 | 2.20 |
| ZrN | 7.4 | 2952 | 2.0 | 9.0 | 2.01 |
| TaN | 14.3 | 3090 | 2.2 | 9.0 | |
| WN | 17.8 | 2950 | 2.58~2.71 | 9.0 | 3.30 |
| NbN | | | 2.3 | — | — |
| VN | | | 2.4 | — | — |
| MgN | | | — | — | — |
| CrN | | | 2.2 | — | — |

In this case, a nitride-based material may be at least one of TIN, Si₃N₄, and AlN.

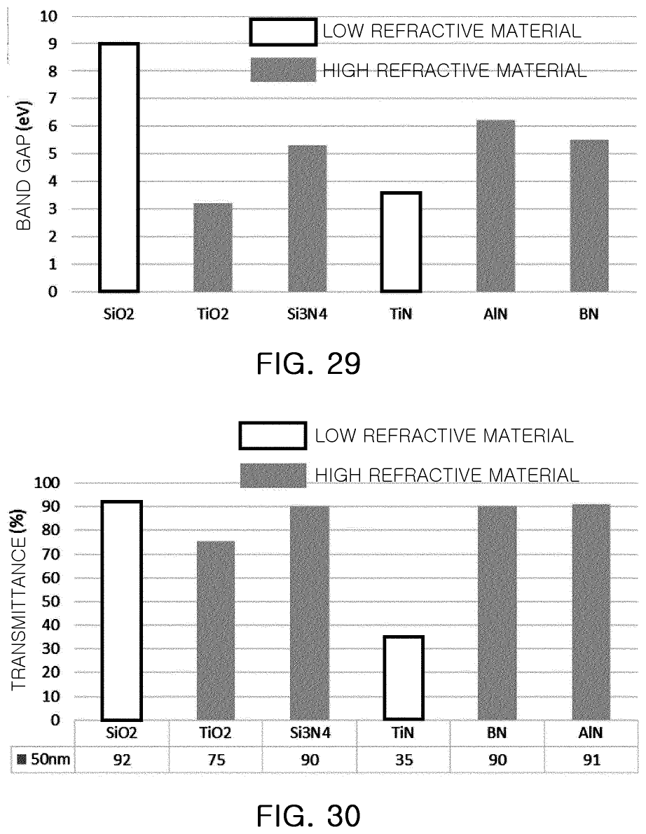

FIG. 29 is a graph illustrating a band gap for each material. FIG. 29 schematizes band gaps of TiO₂, SiO₂, and selected nitride materials.

Referring to FIG. 29, among nitride-based materials, a material that may replace SiO₂ as a low refractive index material is TIN, which has a refractive index of about 1.38.

Additionally, the remaining Si₃N₄, BN, and AlN may be classified as high-refractive index materials capable of replacing TiO₂.

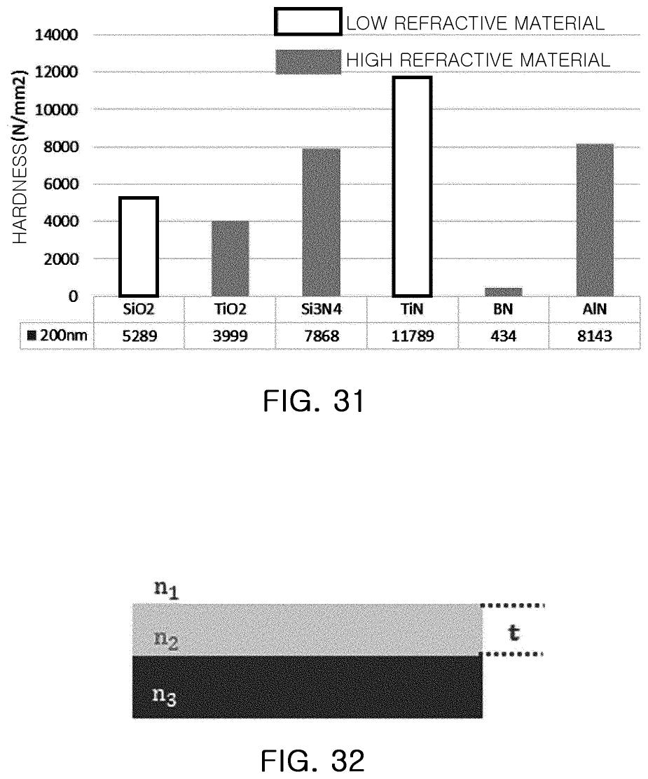

FIG. 31 is a graph illustrating the measurement results of a nano-indenter for each material, which are obtained by measuring the hardness of the thin film using the nano-indenter by depositing a thin film for each material by a thickness of 200 nm.

As a result of the measurement, except for BN, Si₃N₄, TIN, and AlN, all showed higher hardness than oxide materials.

In the case of BN, after deposition, BN reacts with moisture and oxygen in the air to form B₂O₃ (OH) hydroxide, which reduces adhesion to glass over time, and when measuring a corresponding sample with the nano-indenter, a hardness value thereof is also measured to be low.

Accordingly, BN is deemed unsuitable for use in the AR coating layer due to these material characteristics.

Accordingly, in the AR coating layer in an example embodiment of the present disclosure, the fourth layer 204 may be formed of TiN, and the third layer 203 may be formed of Si₃N₄ or AlN. FIG. 30 is a graph illustrating the transmittance of each material.

In order to check the transmittance, SiO₂, TiO₂, Si₃N₄, TIN, BN, and AlN materials are deposited to a thickness of 50 nm using an E-beam evaporator. In this case, the substrate used is glass with a thickness of approximately 650 um.

Referring to FIG. 30, as a result of measuring the transmittance of each deposited sample, most materials represent a transmittance (@550 nm) of 70% or more, but TiN represents an optical coefficient of about 35%.

Accordingly, in order to use TiN optically, the layer thickness may be 50 nm or less to reduce a loss of the transmittance.

This thickness may be measured utilizing both non-destructive and destructive testing.

Non-destructive testing includes methods using an ellipsometer, a reflectometer, and an atomic force microscope.

As an example of destructive analysis, after processing a cross-section on the AR coating layer with a Focused Ion Beam (FIB), a transmission electron microscope (TEM) analysis may be performed, and components may also be analyzed through an EDS analysis. In addition, analysis is possible using FT-IR, XPS, and the like.

The cross-section of the AR coating layer may include a central portion of the lens portion 110, that is, the thickest region of the lens portion 110.

In addition, the thickness of the AR coating layer may be defined as a distance measured in a direction perpendicular to a surface thereof, and may be determined as a value obtained by averaging values measured in a plurality of regions spaced apart from each other at equal intervals.

The water-repellent layer 120 is disposed on one surface of the AR coating layer 210.

Additionally, the water-repellent layer 120 is adopted for the purpose of preventing surface oxidation of the lens portion 110 and providing an automatic cleaning effect to obtain a clear image, and includes a water repellent.

In this case, as the water repellent, perfluoropolyether (PFPE) containing fluorine polymers, polytetrafluoroethylene (PTFE), fluorinated ethylene propylene (FEP), perfluoroalkyl vinyl ether copolymer (PFA), polyvinyl fluoride (PVF), and the like, may be used.

The water-repellent layer 120 may be formed by coating the water repellent on one surface of the AR coating layer 210 using an E-beam or thermal deposition process.

Meanwhile, a functional coating layer (not illustrated) may be further disposed between the AR coating layer 210 and the water-repellent layer 120, if desired.

The functional coating layer is intended to prevent UV reliability from be reduced, and may include a UV improvement additive to achieve this purpose.

Examples of the UV improvement additive may include a UV absorber, an antioxidant, and a hindered amine light stabilizer.

The antioxidant may be, preferably, a phenolic type or a phosphate type, and may use a single type or a mixture of two or more types selected from tetrakismethylene (3,5-di-tert-butyl-4-hydroxycinnamenate) methane, octodecyl 3,5-di-tert-butyl-4-hydroxyhydrocinnamate, ethylenebis(oxyethylene)bis-3-tert-butyl-4-hydroxy-5-methylhydrocinnamenate, n-octadecyl-3-(3′,5′-di-tert-butyl-4′-hydroxy phenyl) propionate, triethyleneglycol bis[3-(3-tert-butyl-4-hydroxy-5-methylphenyl) propionate], 3,9-bis-[1,1-di-methyl-1-2-(3-tert-butyl-4-hydroxy-5-methylphenyl) propionylethyl]-2,4,8,10-tetraoxaspino[5,5] undecane, 2,2-thio diethylene bis[3-(3,5-di-tert-butyl-4-hydroxyphenyl) propionate, tetrakis[methylene-3 (3′5′-di-tert-butyl-4′-hydroxyphenyl) propionate]methane, benzene propionic acid, and 3,5-bis-(1,1-dimethyl-ethyl)-4-hydroxy-C7˜C9 pulverized alkyl ester, and may use a single type or a mixture of two or more types selected from tetrakismethylene (3,5-di-tert-butyl-4-hydroxycinnamenit) methane, octodecyl 3,5-di-tert-butyl-4-hydroxyhydrocinnamate, benzene propionic acid, and 3,5-bis-(1,1-dimethyl-ethyl)-4-hydroxy-C7-C9 pulverized alkyl ester.

The hindered amine light stabilizer may include one or more types selected from N-(4-alkoxycarbonylphenyl)-N′-alkyl-N′-phenylformamide, hydroxyphenylbenzotriazole, bis-(1,2,2,6,6-pentamethyl-4-piperidyl)cebate, and bis-(1-octyl-2,2,6,6-tetramethyl-4-piperidyl)cebate, and may include a single type or two or more types selected from N-(4-methoxycarbonylphenyl)-N′-methyl-N′-phenylformamidine, N-(4-ethoxycarbonylphenyl)-N′-methyl-N′-phenylformamidine and N-(4-ethoxycarbonylphenyl)-N′-ethyl-N′-phenylformamidine.

The functional coating layer may be formed by coating one surface of the AR coating layer 210 with the UV improvement additive through a thermal or E-beam process.

Additionally, the UV improvement additive may include inorganic particles. In an example, the UV absorber may include inorganic particles.

Additionally, the UV absorber may use a single type or a mixture of two or more types selected from methyl 2-(3-tert-butyl-2-hydroxy-5-methoxyphenyl)-2H-benzotriazole-5-carboxylate, methyl 2-(2-hydroxy-5-methoxy-3-tert-octylphenyl)-2H-benzotriazole-5-carboxylate, octyl 2-(3-tert-butyl-2-hydroxy-5-methoxyphenyl)-2H-benzotriazole-5-carboxylate, 2-ethylhexyl 2-(3-tert-butyl-2-hydroxy-5-methoxyphenyl)-2H-benzotriazole-5-carboxylate, octyl 2-(3-tert-butyl-2-hydroxy 5-octyloxyphenyl)-2H-benzotriazole-5-carboxylate, methyl 2-[3-tert-butyl-2-hydroxy-5-(2-methacryloyloxyethoxy)phenyl]-2H-benzotriazole-5-carboxylate, phenyl 2-(3-tert-butyl-2-hydroxy-5-methoxyphenyl)-2H-benzotriazole-5-carboxylate, 2-methacryloyloxy ethyl 2-(2-hydroxy-5-methoxyphenyl)-2H-benzotriazole-5-carboxylate, 2-acryloyloxyethyl 2-(3-tert-butyl-2-hydroxy-5-methoxyphenyl)-2H-benzotriazole-5-carboxylate, 2-methacryloyloxyethyl 2-3-tert-butyl-2-hydroxy-5-methoxyphenyl)-2H-benzotriazole-5-carboxylate.

In the case of forming the UV absorber using only the organic materials, a chemical structure of the organic material may be deformed by a photon energy of UV light, and accordingly, there is a possibility that discoloration and deformation of the UV absorber may occur.

When inorganic particles are used as the UV absorber, since such discoloration and deformation due to the UV light may be minimized, the reliability of lens 101 may be improved.

Additionally, the UV absorber does not have to be implemented only with inorganic components and may further include organic materials.

As the UV absorber includes more organic material, an absorbable UV wavelength band may be widened, thereby further improving UV absorption efficiency.

Examples of organic materials that can be included in the UV absorber include benzophenones, oxalanilides, benzotriazoles, triazines, and each material has advantages such as low costs (benzophenones), low metachrosis (oxalanilides), and high absorbance (benzotriazoles and triazines).

On the other hand, the antioxidant and the light stabilizer may include inorganic particles and organic materials similar to those included in the UV absorber described above, and detailed descriptions will be omitted to avoid duplication.

Additionally, considering the function of a functional coating layer, the thickness of the functional coating layer may be thinner than that of the water repellent layer 120.

Here, the thickness of the functional coating layer may be measured using a non-destructive test or a destructive test.

FIGS. 5 to 23 are cross-sectional views illustrating various embodiments of the AR coating layer of the present disclosure.

Hereinafter, various embodiments of the AR coating layer will be described with reference to FIGS. 5 to 23.

FIG. 5 and FIG. 6 are cross-sectional views illustrating that an AR coating layer is formed by alternately stacking an oxide- and nitride-based material.

As illustrated in FIG. 5, an AR coating layer 220 of the lens has a structure in which a first layer 201, which is a low refractive index layer and is formed of an oxide-based material, and a third layer 203, which is a high refractive index layer and is formed of a nitride-based material, are alternately stacked.

Referring to FIG. 6, an AR coating layer 221 of the lens has a structure in which a second layer 202, which is a high refractive index layer and is formed of an oxide-based material, and a fourth layer 204, which is a low refractive index layer and formed of a nitride-based material, are alternately stacked.

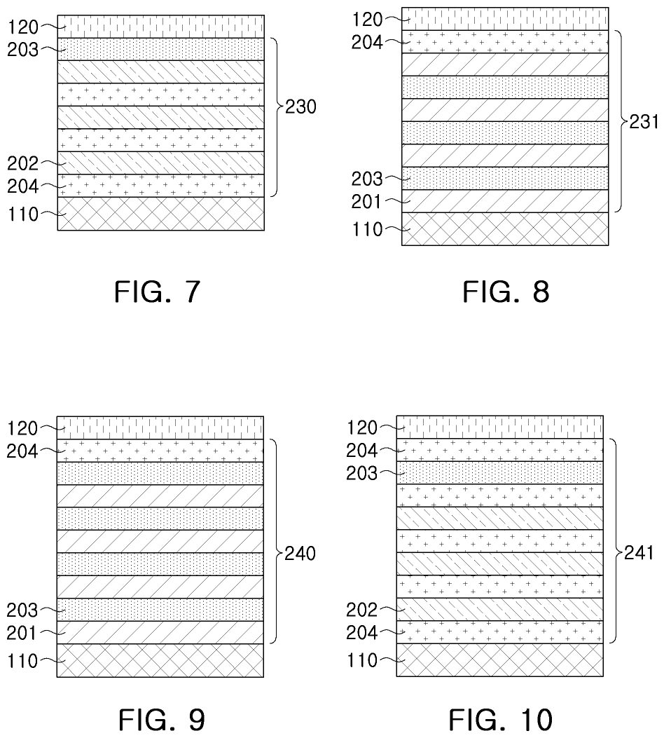

FIGS. 7 and 8 are cross-sectional views illustrating that an AR coating layer is configured by alternately stacking an oxide-based and nitride-based material and disposing the nitride-based material on an uppermost end thereof.

Referring to FIG. 7, an AR coating layer 230 of the lens is configured by alternately stacking a fourth layer 204, which is a low refractive index layer and is formed of a nitride-based material, and a second layer 202, which is a high refractive index layer and is formed of an oxide-based material. The third layer 203, a high refractive index layer formed of a nitride-based material, is disposed on the second layer 202, at the uppermost end.

Referring to FIG. 8, an AR coating layer 231 of the lens is configured by alternately stacking a first layer 201, which is a low refractive index layer and is formed of an oxide-based material, and a third layer 203, which is a high refractive index layer and is formed of a nitride-based material. A fourth layer 204, a low refractive index layer formed of a nitride-based material, is disposed on the first layer 201 at the uppermost end.

FIGS. 9 and 10 are cross-sectional views illustrating an AR coating layer configured by alternately stacking an oxide-based material and a nitride-based material and stacking two or more layers of nitride-based materials at an uppermost end thereof.

Referring to FIG. 9, an AR coating layer 240 of the lens has a structure in which a first layer 201, which is a low refractive index layer and is formed of an oxide-based material, and a third layer 203, which is a high refractive index layer and is formed of a nitride-based material, are alternately stacked. The third layer 203 and a fourth layer 204, as a nitride-based low refractive index layer, are alternately stacked at the uppermost end thereof.

Referring to FIG. 10, an AR coating layer 241 of the lens has a structure in which a second layer 202, which is a high refractive index layer and is formed of an oxide-based material, and a fourth layer 204, which is a low refractive index layer and is formed of a nitride-based material, are alternately stacked. The third layer 203 and the fourth layer 204 are stacked alternately at the uppermost end of the AR coating layer 241 at least once.

According to the structures of FIGS. 9 and 10, the hardness of the lens can be further improved.

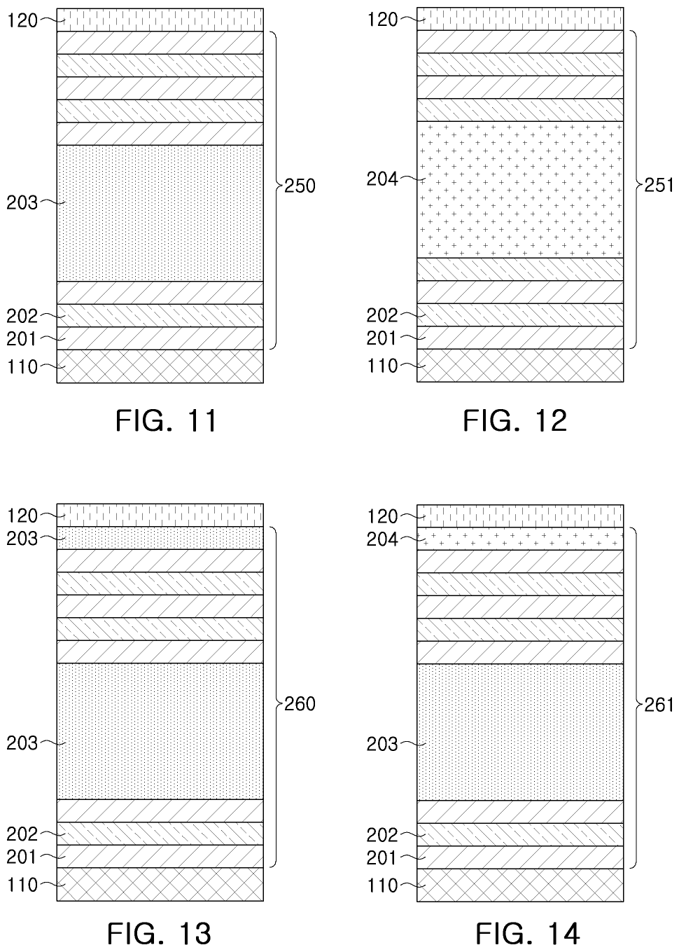

FIGS. 11 and 12 are cross-sectional views illustrating that an AR coating layer has a thick layer formed of a nitride-based material disposed in an intermediate portion thereof.

Referring to FIG. 11, an AR coating layer 250 of the lens is configured so that a first layer 201 and a second layer 202 are alternately stacked from a lower end thereof, and a third layer 203, a high refractive index layer, is disposed on the first layer 201, a low refractive index layer in an intermediate portion thereof, and in this case, the third layer 203 is disposed to be relatively thicker than the first and second layers 201 and 202.

Referring to FIG. 12, an AR coating layer 251 of the lens is configured so that a first layer 201 and a second layer 202 are alternately stacked from a lower end thereof, and a fourth layer 204, a low refractive index layer, is disposed on the second layer 202, a high refractive index layer in an intermediate portion thereof. In this case, the fourth layer 204 is relatively thicker than the first and second layers 201 and 202.

In this manner, when the intermediate portion of the AR coating layer is formed of a thick nitride-based material, these third or fourth layers 203 and 204 may serve as a matrix to further improve the overall hardness of the lens.

FIGS. 13 to 16, 19, and 20 are cross-sectional views illustrating that an AR coating layer has a thick layer formed of a nitride-based material in an intermediate portion thereof, and a layer formed of a nitride-based material is disposed at an uppermost end thereof.

Referring to FIG. 13, an AR coating layer 260 of the lens is configured so that a first layer 201 and a second layer 202 are alternately stacked from a lower end thereof, and a third layer 203, a high refractive index layer, is disposed on the first layer 201, a low refractive index layer in an intermediate portion thereof. In this case, the third layer 203 is relatively thicker than the first and second layers 201 and 202.

Additionally, a third layer 203, a high refractive index layer formed of a nitride-based material, is disposed on the first layer 201 at the uppermost end of the AR coating layer 260.

Referring to FIG. 14, an AR coating layer 261 of the lens is configured so that a first layer 201 and a second layer 202 are alternately stacked from a lower end thereof, and a fourth layer 204, a low refractive index layer, is disposed on the second layer 202, a high refractive index layer in an intermediate portion thereof. In this case, the fourth layer 204 is disposed to be relatively thicker than the first and second layers 201 and 202.

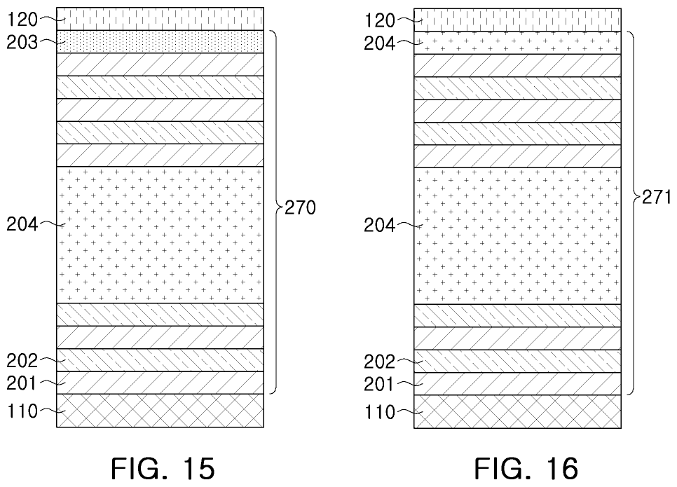

Additionally, a fourth layer 204, a low refractive index layer formed of a nitride-based material, is disposed on the first layer 201 at the uppermost end of the AR coating layer 261. Referring to FIG. 15, an AR coating layer 270 of the lens is configured so that a first layer 201 and a second layer 202 are alternately stacked from a lower end thereof, and a fourth layer 204, a low refractive index layer, is disposed on the second layer 202, a high refractive index layer in an intermediate portion thereof. In this case, the fourth layer 204 is disposed to be relatively thicker than the first and second layers 201 and 202.

Additionally, a third layer 203, a high refractive index layer formed of a nitride-based material, is disposed on the first layer 201 at the uppermost end of the AR coating layer 270.

Referring to FIG. 16, an AR coating layer 271 of the lens is configured so that a first layer 201 and a second layer 202 are alternately stacked from a lower end thereof, and a fourth layer 204, a low refractive index layer, is disposed on the second layer 202, a high refractive index layer in an intermediate portion thereof. In this case, the fourth layer 204 is disposed to be relatively thicker than the first and second layers 201 and 202.

Additionally, a fourth layer 204, a low refractive index layer formed of a nitride-based material, is disposed on the first layer 201 at the uppermost end of the AR coating layer 271.

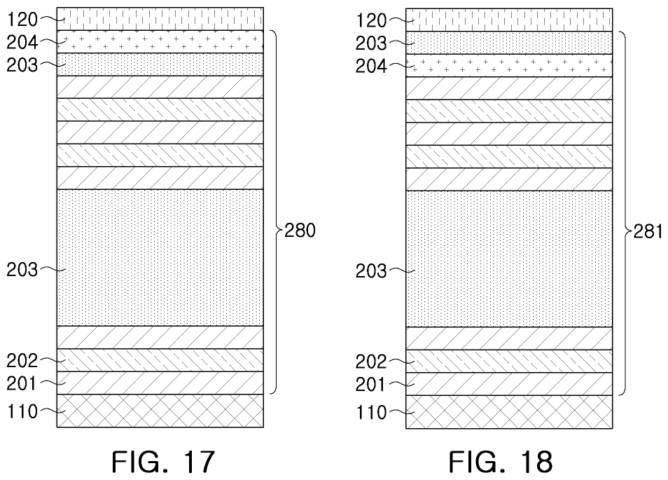

An AR coating layer 290 in FIG. 19 is similar to the AR coating layer illustrated in FIG. 17, and has a thick fourth layer 204 disposed on the second layer 202 in an intermediate portion thereof.

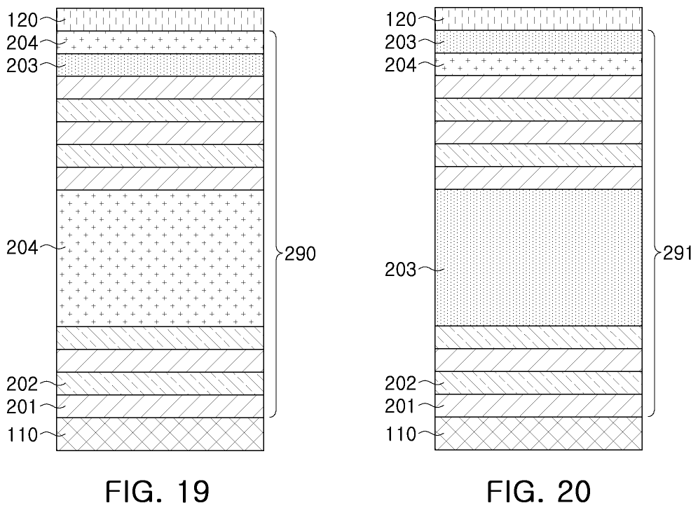

The AR coating layer 291 of FIG. 20 is similar to the AR coating layer illustrated in FIG. 18, and has a thick fourth layer 204 disposed on the second layer 202 in an intermediate portion thereof.

FIGS. 17 and 18 are cross-sectional views illustrating that an AR coating layer has a thick layer formed of a nitride-based material in an intermediate portion thereof, and two or more layers formed of a nitride-based material are stacked at an uppermost end thereof.

An AR coating layer 280 of FIG. 17 is configured so that in the structure of the AR coating layer illustrated in FIG. 13, a fourth layer 204, which is a low refractive index layer and is formed of a nitride material, is disposed on a third layer 203 at an uppermost end thereof.

An AR coating layer 281 in FIG. 18 is configured so that in the structure of the AR coating layer illustrated in FIG. 14, a third layer 203, which is a high refractive index layer and is formed of a nitride material, is disposed on a fourth layer 204 at an uppermost end thereof.

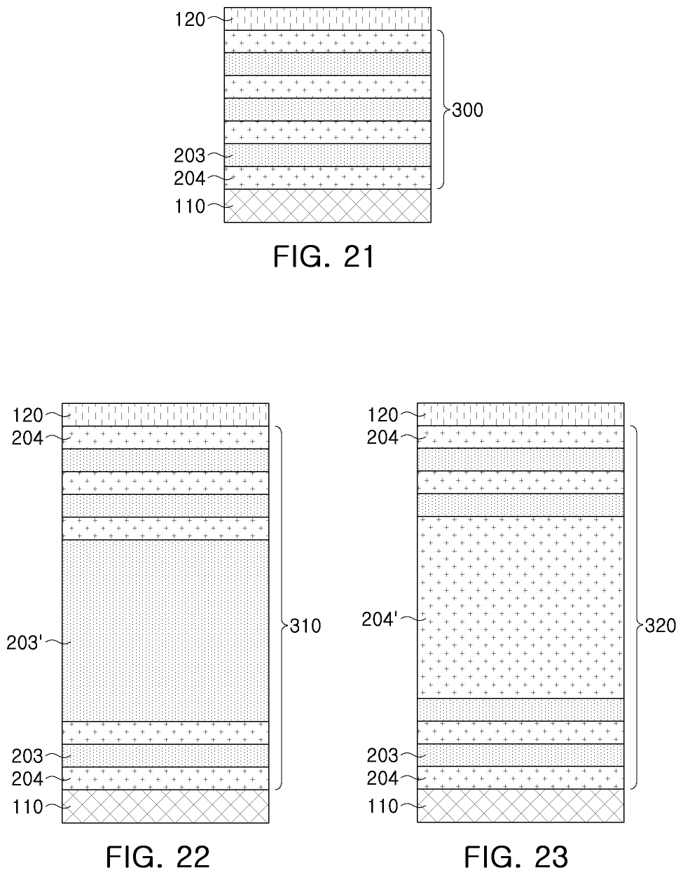

FIGS. 21 to 23 illustrates an AR coating layer consisting of a nitride-based material.

Referring to FIG. 21, an AR coating layer 300 of the lens has a structure in which a fourth layer 204 and a third layer 203 are alternately stacked from a lower end thereof.

Referring to FIG. 22, an AR coating layer 310 of the lens has a structure in which, in the structure of FIG. 21, a third layer 203′ thicker than the other third and fourth layers 203 and 204 is disposed in an intermediate portion thereof.

Referring to FIG. 23, an AR coating layer 320 of the lens has a structure in which, in the structure of FIG. 21, a fourth layer 204′ thicker than the other third and fourth layers 203 and 204 is disposed in an intermediate portion thereof.

As the use of the lens 100 diversifies, there is an increasing desire to properly protect the lens 100 from the external environment. In the case of a lens always exposed to the outside, like a vehicle camera used for electrical components, this need is further increased.

As illustrated in FIG. 37, a lens assembly of an electrical camera may include a plurality of lenses 610, 620, 630, 640, 650, 660, and 670, an IR filter 680, a cover glass 690, and a PCB board 700.

In this case, a lens structure including an AR coating layer and a water-repellent layer, according to example embodiments of the present disclosure, may be applied to the lens 610 disposed at the forefront thereof.

An aspect of the present disclosure provides a lens capable of preventing contamination and scratches caused by an external environment by increasing hardness while improving an anti-reflective effect.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens, comprising:
a lens portion;
a multilayer anti-reflective (AR) coating layer, including either one or both of a low refractive index layer and a high refractive index layer, disposed on one surface of the lens portion; and
a water-repellent layer, including a water repellent, disposed on one surface of the multilayer AR coating layer,
wherein either one or both of the low refractive index layer and the high refractive index layer are formed of a nitride-based material with a band gap greater than 3.1 eV.

2. The lens of claim 1, wherein the low refractive index layer comprises a first layer formed of SiO₂, and
the high refractive index layer comprises a second layer formed of TiO₂.

3. The lens of claim 1, wherein the low refractive index layer comprises a fourth layer formed of a nitride-based material, and
the high refractive index layer comprises a third layer formed of a nitride-based material.

4. The lens of claim 3, wherein the fourth layer is formed of TiN, and the third layer is formed of either Si₃N₄ or AlN.

5. The lens of claim 4, wherein a thickness of the fourth layer is 50 nm or less.

6. The lens of claim 1, wherein the low refractive index layer comprises a first layer formed of SiO₂ and a fourth layer formed of a nitride-based material, and
the high refractive index layer comprises a second layer formed of TiO₂ and a third layer formed of a nitride-based material.

7. The lens of claim 6, wherein in the multilayer AR coating layer, the first layer and the second layer are alternately stacked, and an uppermost portion thereof is a third layer or a fourth layer.

8. The lens of claim 1, wherein the low refractive index layer comprises a first layer formed of SiO₂, and
the high refractive index layer comprises a third layer formed of a nitride-based material.

9. The lens of claim 8, wherein on the first layer of an uppermost end of the multilayer AR coating layer, either one or both of the third layer and a fourth layer a low refractive index layer formed of a nitride-based material, is further disposed as one or more layers.

10. The lens of claim 1, wherein the low refractive index layer comprises a fourth layer formed of a nitride-based material, and
the high refractive index layer includes a second layer formed of TiO₂.

11. The lens of claim 10, wherein on the second layer of an uppermost end of the multilayer AR coating layer, either one or both of the fourth layer and a third layer, a high refractive index layer formed of a nitride-based material, is further disposed as one or more layers.

12. The lens of claim 1, wherein in the multilayer AR coating layer, a first layer and a second layer are alternately stacked, and a third layer having a high refractive index or a fourth layer having a low refractive index, formed of a nitride-based material, is disposed in an intermediate portion thereof.

13. The lens of claim 12, wherein either the third layer or the fourth layer is formed to be thicker than the first layer and the second layer.

14. The lens of claim 12, wherein either one or both of the third layer or the fourth layer is further disposed at an uppermost end of the multilayer AR coating layer as one or more layers.

15. The lens of claim 1, further comprising:
a functional coating layer, including a UV improvement additive, disposed between the multilayer AR coating layer and the water-repellent layer.
